(19) United States
(12) Patent Application Publication
(10) Pub. No.: US 2013/0292222 A1
(43) Pub. Date: Nov. 7, 2013

(54) DEVICE FOR ELECTRICALLY CONNECTING PARTICULARLY A SHIP IN A PORT

(71) Applicant: Damien Feger, Vernon (FR)

(72) Inventor: Damien Feger, Vernon (FR)

(73) Assignee: NEW GENERATION NATURAL GAS, Paris (FR)

(21) Appl. No.: 13/993,379

(22) PCT Filed: Dec. 12, 2011
(86) PCT No.: PCT/FR2011/052936

§ 371 Date: Jul. 18, 2013

(30) Foreign Application Priority Data
Dec. 13, 2010 (FR) 1060422

(51) Int. Cl. H02G 11/00

(52) U.S. Cl. CPC H02G 11/00
USPC 191/12 R

(57) ABSTRACT

Connection device (1) designed to connect, particularly a ship in a port, includes a connector (2), a carriage (3) forming a housing (17) for the connector when it is not connected, and a runway track (4) on which to move the carriage, the connector being designed to be connected by cable (30) to a land-based network. Such a device ensures that the correct positioning of the ship relative to the connector can be guaranteed.

The present invention relates to the field of high-power electrical supplies. It more particularly relates to a device for powering a ship when it is docked.

A ship, for example a container ship or a cruising boat, needs significant electricity when it is docked. This electricity is generally in the vicinity of several megawatts, typically from 8 to 12 MW, for three-phase voltages of 6,500 V or 11,000 V. This power is generally provided by the onboard diesel generator sets. These onboard generator sets have a low efficiency, use expensive energy, and generate considerable pollution. Furthermore, in particular a methane tanker, which uses the gases evaporating in its tanks as fuel, is often able to produce more energy than it consumes. It may therefore export current toward a land-based grid competitively.

Devices have been designed that at least make it possible to power a docked ship without using the ship's own generator sets. Some of these devices are also provided to export current toward the land-based grid.

Such devices are in particular known from document FR 2,946,471. These devices comprise a dock outlet housed in a container. These devices assume a sufficiently precise alignment of an outlet onboard the ship, vertically above the dock outlet. This in particular involves sufficiently precise positioning of the ship along the dock. This precision is difficult to obtain, offset by the possibility of moving the container. Furthermore, the container takes up considerable space on the dock, is not very aesthetically pleasing on a “passenger” dock, and is bulky on a “freight” dock; the cables powering the container must be able to be pulled based on its movement and also clutter the dock.

The invention aims to propose an improved device that allows a traveling object, in particular a docked ship, to connect vertically to a land-based current outlet, while forming a sufficient shelter for that land-based outlet, and offering a solution to at least some of the aforementioned problems.

According to the invention, such a land-based electrical power device for a traveling object, in particular a ship, is characterized in that it comprises a connector, a carriage forming a shelter for the connector when it is not connected, and a rolling track to move the carriage, the connector being provided to be connected by cables to a land-based grid. Advantageously, the device, preferably the carriage, comprises motor means to move the carriage on the rolling track.

The device according to the invention is advantageously provided with a shelter provided to house the connector in the carriage when the connector is not connected. The carriage may bear a wall element positioned such that, when the carriage is in the shelter, the wall element forms a sealed door with other wall elements of the shelter. The connector may comprise an opening to insert connection means for the mobile device therein, one edge of the opening advantageously bearing a seal positioned so as to provide sealing against a wall of the shelter when said connector is housed therein.

The traveling object may be a ship; the device then advantageously comprises means for being fastened along a dock. It may be designed to be positioned between the dock and fenders.

Several embodiments of the invention are described hereafter, as non-limiting examples, in reference to the appended drawings, in which:

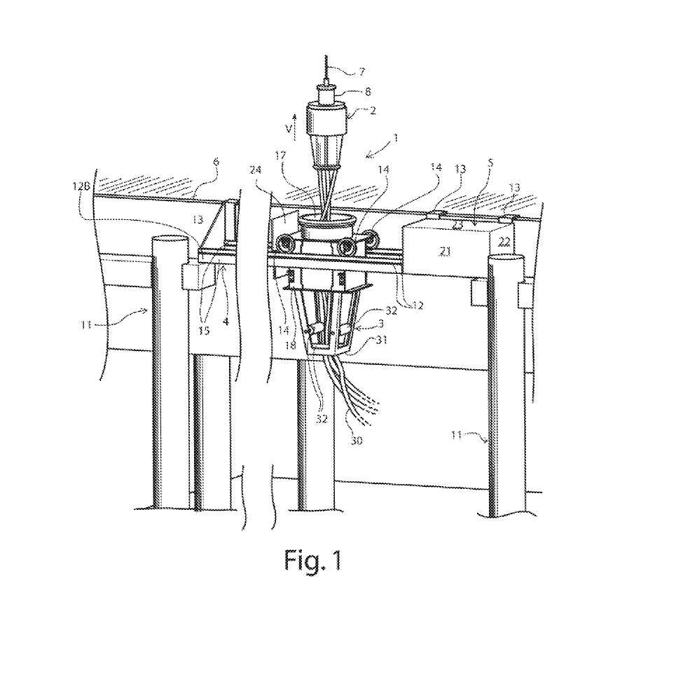

FIG. 1 is a perspective view of an electrical connection device according to the invention, whereof the land-based connector is being pulled, to be connected on a ship; and

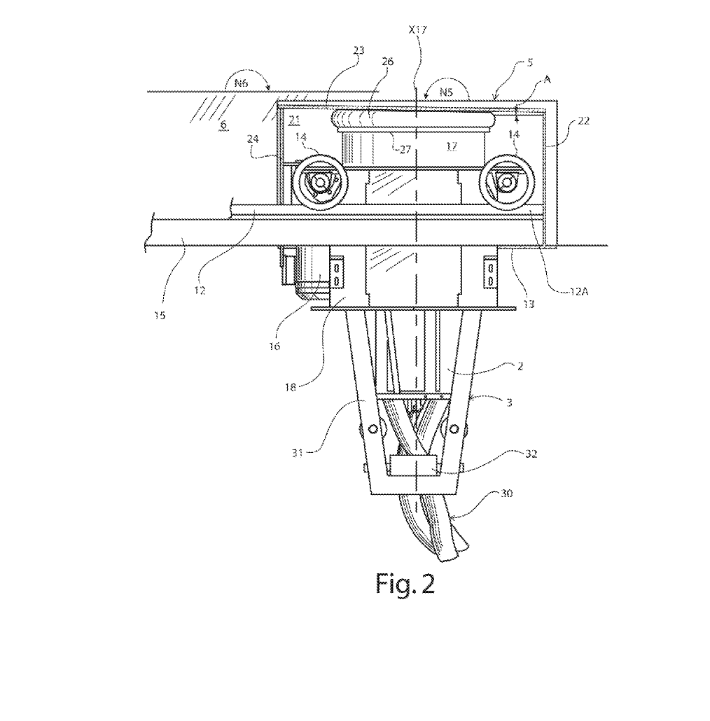

FIG. 2 is a partial diagrammatic longitudinal elevation view, in the standby position, of the device of FIG. 1.

The connection device 1, illustrated in FIGS. 1 and 2, is the land-based part of a connection system making it possible to connect the ship, not shown in the figures, to a land-based electrical grid. Such a system may make it possible to power the ship from a land-based grid, or, on the contrary, to power that grid with electricity produced onboard the ship, for example from gas when the ship is for instance a methane tanker.

The device 1 in particular comprises a connector 2, a carriage 3, a rolling track 4 and a shelter 5. In FIG. 1, the device is shown positioned along a dock 6.

The connector 2 is provided to be pulled, from the carriage 3 that serves as a support for it, toward the ship. In the illustrated example, the ship comprises a cable 7, one end of which supports a shuttle 8. When the ship is docked, the cable 7 is deployed and the shuttle 8 is lowered to the end of the cable 7 until it engages with the connector 2. Then, the cable is folded, pulling the connector 2 vertically upward, in the direction V. The connector 2 is pulled until it is engaged with the complementary connector, not shown, onboard the ship, thereby establishing electrical continuity between the ship and the land-based electrical grid. In FIG. 1, the connector 2 is shown while being pulled upward, along V, whereas it has just been removed from the carriage, by the cable 7 and the shuttle 8.

In the example illustrated in FIG. 1, fenders 11 are positioned at the front of the dock 6 to protect it. The device 1 is positioned at the front of the dock between two fenders 11, such that a ship at the dock 6, and bearing against the fenders, does not damage the device 1 or hinder the operation thereof. Furthermore, the device 1 is positioned such that the highest level N5 remains lower than or equal to the level N6 of the dock. Thus, the device 1 does not in any way hinder the maneuvers of the engines and goods on the dock 6. In the illustrated example, the level N5 is the upper level of the shelter 5.

The rolling track is formed by two rails 12, positioned parallel to each other and the dock 6. Each rail is supported by a respective beam 15. The beams are fastened to the dock 6 by angle brackets 13. The carriage 3 comprises two pairs of wheels 14, provided to roll on the rails 12, and a motor 16 provided to drive a least one of the wheels 14 and allow movement of the carriage on the rails, along the dock 6.

The carriage 3 further comprises a substantially cylindrical housing 17 around a substantially vertical axis X17. The housing is provided to cover the connector therein 2, when it is not connected to a ship. The housing is mounted in a body 18. The pairs of wheels 14 are fastened, on either side of an upper edge of the body 18, each by a respective axle. The body extends between the rails 12 vertically, above and below the rails.

The shelter 5 is positioned at a first end 12A of the rolling track 4. It makes it possible to house the carriage 3 and the connector 2 therein when they are not in use, while waiting for a ship to dock. The shelter has a substantially parallelepiped shape. It comprises three vertical walls 21, 22 and a wall forming a lid 23. The vertical walls 21, 22 extend upward from the base of the beams 15, as far as the lid 23; the vertical walls are connected to each other and the lid so as to be sealed against water and projections. The vertical walls comprise two side walls 21, positioned parallel to the rails 12 and on either side thereof. The vertical walls further comprise a bottom 22 positioned transversely to the rails and against the first end 12A of the rolling track, such that the rails 12 extend from the bottom wall 22, first through the shelter 5, then beyond, as far as a second end 12B of the rails.

The body supports a vertical wall element 24 positioned such that when the carriage 3 is in the shelter 5, the wall element 24 closes the shelter, across from the bottom 22, preferably sealably with the side walls 21 and the lid 23. Furthermore, the housing 17 protrudes upward from the body 18. A hollow O-ring 26 is fastened along an upper edge 27 of the housing 17. The edge 27 defines an opening provided to have the connection means specific to the ship penetrate therein.

The lid 23 is slightly inclined, lower on the side of the bottom 22; the edge 27 is also inclined, substantially by the same angle as the lid 23, such that the lid 23 forms a bearing surface substantially parallel to the plane of the seal 26. Thus, when the connector 2, supported by the carriage 3, enters the shelter 5, the seal 26 is pressed under the lid 23; as a result, when the connector 2 is in a standby position, in the housing 17 and the shelter 5, its inside is protected from anything that may enter from above. The slope A of the lid may, for example, be close to 5% relative to the horizontal, toward the first end 12A of the rolling track.

The connector 2 is connected to the three-phase land-based grid by a plait 30 of several cables, including four power cables, for the three phases and the ground, as well as one or more control cables. When the connector moves between the carriage and the ship, as particularly illustrated in FIG. 1, the plait 30 slides vertically through the carriage 3. The carriage comprises a chassis 31 that extends downward from the body 18 and that bears, at its end, four rollers 32 forming a passage between them for the cables and ensuring guiding and sliding thereof with reduced effort, through the carriage 3, substantially along the axis X17 of the housing 17.

Of course, the invention is not limited to the examples described above.

Thus, other movement and rolling track means can be provided. For example, a single-rail carriage may be provided.

The device may also be provided embedded in a dock rather than being mounted on brackets, as previously described. Furthermore, if the fenders are far enough from the dock, the device according to the invention may advantageously be positioned between the fenders and the dock, such that the device is protected without encroaching on the port facilities.

The device may also be a component or part of a boom making it possible to moor a ship away from a coast.

The guiding of the cables along the axis of the housing may be done without using rollers, or replacing the rollers with sliding skates, for example made from polytetrafluoroethylene.

The means for moving the carriage may also be different from those described. Thus, instead of being carried by the carriage, the motor may be stationary relative to the dock and drive the carriage using a chain or cabling system mounted in a to and fro manner The motor may also be replaced by suitably downshifted manual driving. A rack may also be integrated into the rolling track to avoid skidding of the wheels.

The device according to the invention is particularly useful, since it allows a ship to connect to the land-based grid easily, without requiring excessive precision in the mooring maneuvers, thereby guaranteeing proper positioning of the ship with respect to the connector. Furthermore, it allows the connector to be fully sheltered and protected when it is in the standby position. Furthermore, it should be noted that it may be positioned so as not to encroach on the port facilities, or hinder the operation thereof.

Although it has previously been described for the connection of a ship, the device according to the invention may also be provided for other traveling objects, for example an airplane.

1. A land-based electrical power supply device (1) for a traveling object, in particular a ship, characterized in that it comprises a connector (2), a carriage (3) forming a housing (17) for the connector when it is not connected, and a rolling track (4) to move said carriage therein, said connector being provided to be connected by cables (30) to a land-based grid.

2. The device according to claim 1, characterized in that said device (1), preferably the carriage (3), comprises motor means (16) for moving said carriage (3) on the rolling track (4).

3. The device according to claim 1, characterized in that it further comprises a shelter (5) for sheltering the connector (2) in the carriage (3) when the connector is not connected.

4. The device according to claim 3, characterized in that the carriage bears a wall element (24) positioned such that, when the carriage is in the shelter (5), the wall element (24) forms a sealed door with other walls (21) of said shelter (5).

5. The device according to claim 4, characterized in that the housing (17) comprises an opening for inserting connecting means of the traveling object therein, one edge (27) of said opening bearing the seal (26) is positioned to provide sealing against a wall (23) of the shelter (5) when said connector (2) is sheltered therein.

6. The device according to claim 1, characterized in that the traveling object is a ship and in that said device comprises means (13) for being fastened along a dock (6).

7. The device according to claim 6, characterized in that it is designed to be positioned between the dock (6) and fenders (11).

8. The device according to claim 2, characterized in that it further comprises a shelter (5) for sheltering the connector (2) in the carriage (3) when the connector is not connected.

9. The device according to claim 8, characterized in that the carriage bears a wall element (24) positioned such that, when the carriage is in the shelter (5), the wall element (24) forms a sealed door with other walls (21) of said shelter (5).

10. The device according to claim 3, characterized in that the housing (17) comprises an opening for inserting connecting means of the traveling object therein, one edge (27) of said opening bearing the seal (26) is positioned to provide sealing against a wall (23) of the shelter (5) when said connector (2) is sheltered therein.
